(19) United States
(12) Patent Application Publication
(10) Pub. No.: US 2005/0285743 A1
(43) Pub. Date: Dec. 29, 2005

(54) Method and device for detecting illegal operation of vehicles

(76) Inventor: Tory S. Weber, Calgary (CA)

Correspondence Address: ADE & COMPANY, 1700-360 MAIN STREET, WINNIPEG, MB, R3C3Z3, CA

(21) Appl. No.: 11/154,940

(22) Filed: Jun. 17, 2005

Related U.S. Application Data
(60) Provisional application No. 60/580,704, filed on Jun. 21, 2004.

(51) Int. Cl. G08B 13/14

(52) U.S. Cl. 340/572.1; 340/426.1

(57) ABSTRACT

This document outlines a system and device for detecting incorrect or absent information related to legal operation of a motor vehicle. Information is periodically gathered by an in-vehicle system capable of reading RFID-tagged documents (such as registration and insurance) and vehicle features (such as license plate and vehicle identification number). Radio-frequency transmission of the information (or an abbreviated version thereof) is performed on receipt of a valid RF activation signal from a portable or fixed-location extra-vehicle reading system. Upon receipt of the information, the extra-vehicle reading system ensures that no discrepancy in on-vehicle information is present by performing a local check and consulting an authoritative database. If a discrepancy is encountered, information is missing, or the authoritative database entry is flagged, law-enforcement officials are notified. The system may also be used for detection of moving infractions such as speeding and red light violations and logging of vehicle locations for security purposes.

This application claims the benefit under 35 USC 119 from the priority date of Provisional Application 60/580704 filed 21 Jun. 2004.

This invention is in the fields of identification and detection of moving vehicles, detection and notification of moving violations, verification of legal operation of a motor vehicle, and automobile safety.

### BACKGROUND OF THE INVENTION

Detection of motor vehicle infractions consumes a great deal of law enforcement resources. The benefit to successful detection is great, ranging from direct benefits such as reduction of traffic-related injuries and deaths, to associated benefits such as preemptive curbing of illegal activities. Many crimes are carried out using a stolen or otherwise illegally operated vehicle.

Since 9/11, national security is of paramount importance and stopping crimes before they occur has become a consuming task. This document outlines a system intended to aid law-enforcement officials by automatically detecting and reporting vehicular infractions.

U.S. Pat. No. 6,720,920 to Breed et al. describes a system for communication between- and localization of motor vehicles. Primary focus is on increased safety of motor-vehicle operation through collision-avoidance based upon GPS data and other sensory modalities. Unique identification (in a global sense) of vehicles is not involved, nor is legality of operation evaluated or communicated.

U.S. Pat. No. 6,025,784 to Mish describes integration of either passive or active RFID technology with a license plate or license plate assembly for mounting on a vehicle for the purpose of vehicle identification. The nature of the identifying data is not specified and is contained in a single RFID transponder that is responsible for communication to off-vehicle reading systems. Use of the system for law-enforcement purposes is questioned since the system contains no processor element for encryption of transmissions. Though some current renditions of RFID technology include the ability to encrypt transmissions, a change to the encryption algorithm (beyond the change of keys) is not possible. Additionally, the system described in this patent does not offer the inherent security associated with distributed data.

### SUMMARY OF THE INVENTION

It is one object of the invention to provide an improved method for monitoring vehicle use using RFID tags.

According to the invention there is provided a method for detecting illegal operation of a vehicle comprising:

providing in each of a plurality of vehicles a location for receiving

a vehicle identification RFID tag;

a vehicle Registration RFID tag;

an insurance RFID tag;

providing in the vehicle an RFID tag reader and periodically reading the above tags;

providing in the vehicle an RF module for communication externally of the vehicle;

communicating from an outside sensor to the vehicle a signal to activate the in-vehicle communication system so as to cause the system to transmit data to the sensor representative of the above tags;

and comparing information gathered by the sensor from the transmitted data with database contents, or checking for information integrity and completeness, to determine the legality of the operation of the vehicle.

Preferably there is provided in the vehicle a tag reader for reading the RFID tags in the vehicle.

Preferably the tag reader and tags are located in the glove box.

Preferably there is provided an RF module on or near the exterior of the vehicle for communicating with the sensor.

Preferably the RF module is mounted on the exterior of the vehicle adjacent the license plate and includes a low frequency passive tag reader for reading a tag on the license plate.

Preferably there is provided one or more sensors arranged to detect one or more of:

running of red-lights and stop-signs;

speeding, via placement of two law-enforcement systems at a known distance apart and determining the time interval for detection of the same vehicle; and

operation of a vehicle outside of curfew hours

Preferably facility is made for logging of vehicle position and operating conditions at three levels:

within the in-vehicle system proper;

within the sensor; and

within the law-enforcement database.

According to a second aspect of the invention there is provided an apparatus for use in a vehicle in a method for detecting illegal operation of a vehicle, the apparatus comprising:

a receptacle for receiving and supporting providing in each of a plurality of vehicles a location for receiving

a vehicle identification RFID tag;

a vehicle Registration RFID tag;

an insurance RFID tag;

an RFID tag reader arranged for periodically reading the above tags;

and an RF module for communication externally of the vehicle and arranged in response to communicating from an outside sensor to the vehicle a signal to transmit data to the sensor representative of the above tags.

The specific RFID technology used to read the tags is preferably low-frequency, passive, which is commercially available and known to persons skilled in this art. However other RFID technologies may be used.

In regard to the locale of the on-vehicle RF unit, the unit may be located just inside the vehicle, perhaps with connection to an external antenna. Thus the unit may be located: “on or near the exterior of the vehicle 3.

The system may also include the option of gathering and correlating driver's license information via another RFID tag. An additional reader system may be required, unless the operator is required to place the license in range of the glove box reader.

The database used during correlation of information is preferably an existing law-enforcement (or insurance company) database.

The trend of FCC regulations is to increase the broadcast power, and thus the range, of RFID transponders. With each increase, it becomes more feasible to construct the system with no need for the in-vehicle RFID readers. This application therefore includes also a system of this type. These transponders are typically of the active variety.

### BRIEF DESCRIPTION OF THE DRAWINGS

One embodiment of the invention will now be described in conjunction with the accompanying drawings in which:

FIG. 1 is a top-level block diagram of the system. There are three major components.

FIGS. 2 and 3 show the physical placement of the vehicle feature tags and the components of the in-vehicle reading and communication system.

FIGS. 4 through 10 demonstrate system operation when a vehicle encounters a stationary law-enforcement reading system.

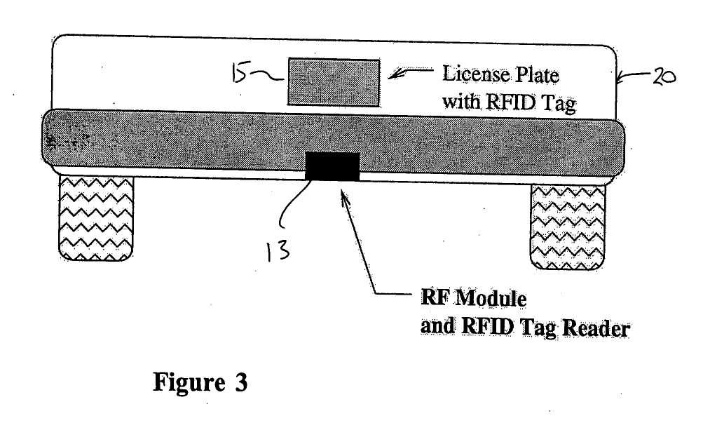

### DETAILED DESCRIPTION

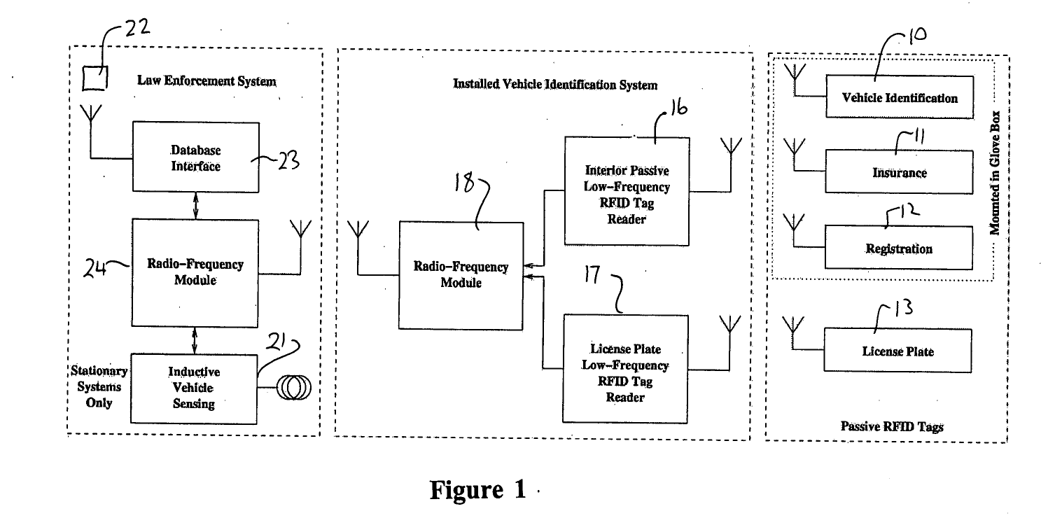

In FIG. 1 is shown a schematic illustration of the system according to the present invention. The system provides four passive RFID tags which are arranged to be located in a suitable location in the vehicle. In the example as shown the tags include a vehicle identification tag, an insurance tag and a registration tag, all of which are arranged to be mounted in a container or receptacle mounted at a suitable location in the vehicle for example in the glove box. The fourth tag shown relates to the license plate and is generally located at the license plate as part of the structure.

The system further includes an interior low frequency passive RFID tag Reader which is located immediately adjacent the three tags within the vehicle again as part of the structure or container or receptacle receiving the three interior tags.

A second low frequency RFID tag reader is located at the license plate so that the two readers are immediately accessible to the respective tags for reading the information therefrom on a periodic basis to ensure that the tags are properly provided and located at the required location.

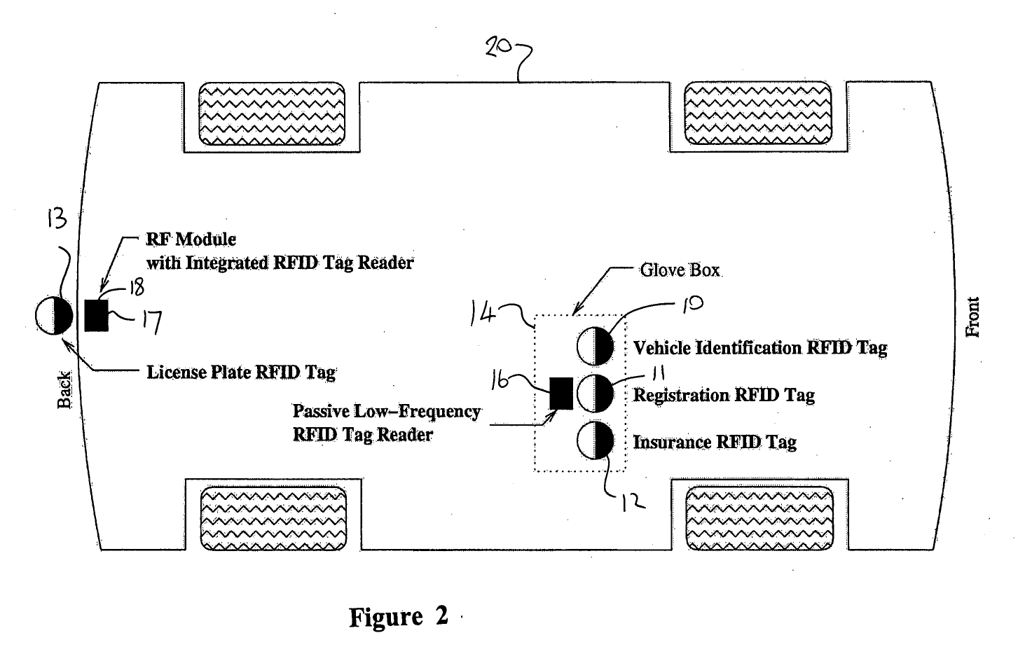

The system further includes the radio frequency module which is preferable formed as part of the second reader or associated therewith since the module is preferable located at or near the exterior of the vehicle adjacent the license plate as best shown in FIGS. 2 and 3.

Separate from the vehicle is provided the exterior systems for detecting the vehicle. These include an inductive vehicle sensing coil for detecting the passage or presence of the vehicle together with a radio frequency module which communicates with the respective module on the vehicle detected. These elements communicate with a database through a database interface. As shown in FIGS. 2 and 3, the three tags are mounted in the suitable mounting device within the glove box together with the first reader. The RF module and the second reader are located at the rear of the vehicle adjacent the license plate so as to read the RFID tag on the license plate and communicate with the first reader for information concerning the first three tags.

The system can also operate with using only some of the tags set forth above or alternative (perhaps additional) tags specially designed for association with the vehicle or the operator which are supplied to the driver or to the owner for insertion into the vehicle.

The vehicle feature RFID tags are integrated with materials issued by local governing authorities or the vehicle manufacturer. The information directly- or indirectly represented by the tags relates to the legal operation of the vehicle.

The in-vehicle reading and communication system portion of the system periodically gathers, summarizes, encodes, and encrypts information from the vehicle feature tags during vehicle operation. When communication with a law-enforcement system is established, this portion of the system communicates this information via a bi-directional RF link.

The law-enforcement system initiates contact with the in-vehicle system, receives the vehicle feature information and verifies its completeness and accuracy using a locally implemented algorithm and the information contained in a remote database. Two configurations of the law-enforcement portion are designed: a hand-held unit for spot-checks, and a stationary unit placed on (or in) a roadway for monitoring moving traffic. Both units include methods for notifying law-enforcement officials of discrepancies in data received from a vehicle.

Typical system operation using a stationary law-enforcement sensor unit is as follows:

The driver enters the vehicle and engages the ignition.

The passive tags are read and information is gathered in the RF unit. Information is periodically re-gathered during vehicle operation.

The vehicle approaches an inductive sensor.

When the inductive sensor is triggered, the law-enforcement system is activated. A signal is sent to activate the in-vehicle system communication system.

The on-board system responds with a summary of vehicle RFID information.

The gathered information is verified locally and against its law-enforcement database entry.

If a discrepancy exists, officials can be notified and optional electronic tagging can occur.

An update to the on-vehicle system (encryption keys and methods, etc.) can be made.

Manual verification of vehicle information is notoriously time-consuming. As an officer checks information by pulling over a vehicle, gathering the information from the operator, and verifying by radio or through a law-enforcement database, hundreds, or even thousands of potentially higher-risk vehicles have passed the site.

Automatic detection using the speed of modern data-communication devices dramatically increases the capabilities of law-enforcement officials. The system is able to check vehicles at rates permitting the verification of every vehicle that passes. For a hand-held unit, an officer is able to perform checks in a matter of moments with no necessity for direct interaction with the operator.

If a vehicle is not flagged by the system (and the officer chooses not to investigate further) more time can be spent on higher-priority concerns. Reallocation of law-enforcement manpower so time can be spent investigating and preventing more damaging crimes has a very positive impact on law-enforcement budgetary concerns and public safety and security.

In comprehensive infraction detection, the range of detected infractions is great. Through comparison of information distributed throughout the system, it is possible to detect the presence and/or validity of:

license plates;

insurance; and

registration.

Detection is performed at two levels: locally and through correlation with data in the law enforcement database.

Additionally, with appropriate placement of system readers, detection of moving violations is automated:

running of red-lights and stop-signs;

speeding, via placement of two law-enforcement systems at a known distance apart and determining the time interval for detection of the same vehicle; and

operation of a vehicle outside of curfew hours.

Facility is made for logging of vehicle position and operating conditions at three levels:

within the in-vehicle system proper;

within the reader system; and

within the law-enforcement database.

Logged information can be used in relation to criminal and accident investigations. Locally stored information is also used for faster correlation and detection of infractions. For example, a vehicle may be electronically flagged (via logging of information in the in-vehicle system) when an infraction is first detected, making subsequent comprehensive information correlation unnecessary.

For robust security, since the information attributed to a vehicle is stored throughout the system, copying is inherently difficult and certainly not within the capabilities of normal citizens.

In the unlikely situation that subversive system duplication has occurred, the system is structured such that vehicles providing duplicate information can be detected in the same manner as other infractions during correlation with the law-enforcement database information. Although authorities would need to manually investigate two vehicles, one would certainly be an offender.

Law-enforcement database interfaces are made secure by necessity. Data communicated over this interface is encrypted. Having a central, authoritative component to the system allows for coordinated security updates.

Information transmitted between the in-vehicle system and the law-enforcement reader is encrypted. Provision is made for updates to encryption keys via the bi-directional nature of the communication link.

The system provides low information volume in that too much information can be less useful than no information at all: analysis and storage can dominate the use of expensive resources. This system allows varying levels of information detail to be transmitted, correlated, and perhaps logged.

With re-locatable and independently activated reading systems, data can be gathered for only high-priority areas. Individual reader systems can be configured such that they report only specific offences, outlined earlier.

The system provides convenience of installation and use in that it requires no vehicle operator/owner interaction beyond initial system installation and placement of RFID-tagged information in appropriate locations in the vehicle. Retrofitting of older vehicles involves placing a vehicle identification tag in a standardized location, and mounting of the in-vehicle components, perhaps in conjunction with existing in-vehicle communication systems and networks.

From an environmental perspective, the system offers the benefit of not having to issue paper documentation that replicates information contained on the RFID tags in electronic form. Many tags are re-programmable, allowing re-use of existing technology.

Additional system uses can be provided in that a special “proprietary mode” is supported wherein with proper authorization access to custom information stored in the in-vehicle system can be accessed and/or updated. Examples of the use of this mode are in roadway toll-collection, automated parking, and automated fuel filling systems.

Since various modifications can be made in my invention as herein above described, and many apparently widely different embodiments of same made within the spirit and scope of the Claims without department from such spirit and scope, it is intended that all matter contained in the accompanying specification shall be interpreted as illustrative only and not in a limiting sense.

1. A method for detecting illegal operation of a vehicle comprising:
providing in each of a plurality of vehicles a location for receiving
a vehicle identification RFID tag;
a vehicle Registration RFID tag;
an insurance RFID tag;
providing in the vehicle an RFID tag reader and periodically reading the above tags;
providing in the vehicle an RF module for communication externally of the vehicle;
communicating from an outside sensor to the vehicle a signal to activate the in-vehicle communication system so as to cause the system to transmit data representative of the above tags to the sensor;
and correlating information gathered by the sensor from the transmitted data locally and/or with a database to determine the legality of the operation of the vehicle.

2. The method according to claim 1 wherein there is provided in the vehicle a tag reader, which is preferably but not necessarily a low frequency passive reader for reading the tags in the vehicle.

3. The method according to claim 2 wherein the tag reader and tags are located in the glove box.

4. The method according to claim 1 wherein there is provided an RF module on or near the exterior of the vehicle for communicating with the sensor.

5. The method according to claim 1 wherein the RF module is mounted on or near the exterior of the vehicle adjacent a license plate and includes a low frequency passive tag reader for reading a tag on the license plate.

6. The method according to claim 1 wherein there is provided one or more sensors arranged to detect one or more of:
running of red-lights and stop-signs;
speeding, via placement of two law-enforcement systems at a known distance apart and determining the time interval for detection of the same vehicle; and
operation of a vehicle outside of curfew hours

7. The method according to claim 1 wherein facility is made for logging of vehicle position and operating conditions at three levels:
within the in-vehicle system proper;
within the sensor; and
within the law-enforcement database.

8. An apparatus for use in a vehicle in a method for detecting illegal operation of a vehicle, the apparatus comprising:
a receptacle for receiving and supporting providing in each of a plurality of vehicles a location for receiving
a vehicle identification RFID tag;
a vehicle Registration RFID tag;
an insurance RFID tag;
an RFID tag reader arranged for periodically reading the above tags;
and an RF module for communication externally of the vehicle and arranged in response to communicating from an outside sensor to the vehicle a signal to transmit data to the sensor representative of the above tags.

9. The apparatus according to claim 8 wherein there is provided in the vehicle a low frequency passive tag reader for reading the tags in the vehicle.

10. The apparatus according to claim 9 wherein the tag reader and tags are arranged to be located in the glove box.

11. The apparatus according to claim 8 wherein there is provided an RF module arranged to be mounted on or near the exterior of the vehicle for communicating with the sensor.

12. The apparatus according to claim 8 wherein the RF module is arranged to be mounted on or near the exterior of the vehicle adjacent a license plate of the vehicle and includes a low frequency passive tag reader for reading a tag on the license plate.
